(19) United States
(12) Patent Application Publication
(10) Pub. No.: US 2012/0189448 A1
(43) Pub. Date: Jul. 26, 2012

(54) EASY MAINTENANCE HYDRAULIC TURBINE ENGINE

(75) Inventors: Thomas Jaquier, Grenoble (FR); Jean-Luc Achard, Grenoble (FR); Jeronimo Zanette, Gieres (FR)

(73) Assignee: Electricite de France, Paris (FR)

(21) Appl. No.: 13/395,176

(22) PCT Filed: Sep. 9, 2010
(86) PCT No.: PCT/FR2010/051883

§ 371 Date: Apr. 13, 2012

(30) Foreign Application Priority Data
Sep. 9, 2009 (FR) 0956120

(51) Int. Cl. F03B 3/00; B23P 11/00

(52) U.S. Cl. 416/124; 29/426.3; 29/428

(57) ABSTRACT

A hydraulic turbine engine comprises, between a seat and a succession of turbine stages associated with at least one generator, a guiding block secured to the lower stage of the turbine engine and nested on the seat, said guiding block containing winders for guiding cables, the ends of which are secured to the seat.

### FIELD OF THE INVENTION

The present invention relates to a cross-flow turbine engine formed of a succession of turbine stages associated with at least one generator stage.

### DISCUSSION OF PRIOR ART

The applicant has filed a set of patent applications relating to cross-flow hydraulic turbine engines, including:

French patent application 04/50209 filed on Feb. 4, 2004 (B6412) relating to a cross-flow hydraulic turbine engine comprising a turbine column, each turbine comprising V-wing blades;

French patent application 05/50420 filed on Feb. 14, 2005 (B6869) relating to a holding structure intended to stiffen a turbine column and to avoid any deformation thereof; and

French patent application 07/58511 filed on Oct. 23, 2007 (B8450) relating to a turbine engine formed of an assembly of two twin columns rotating in reverse directions.

All afore-mentioned publications will be considered as known and hereby incorporated by reference.

The various modular cross-flow hydraulic turbine engines systems are generally mounted on heavy seats or foundations supported by a sea or river bed.

In all such systems, it is desirable to be able to pull the turbine engine up for maintenance or repairs, and to put it back in place. Such operations are particularly complex and/or often require the use of dedicated vessels provided with dedicated equipment.

### SUMMARY

The present invention aims at providing an assembly of turbine engine columns capable of being simply mounted and dismounted from standard vessels provided with standard equipment.

Thus, an embodiment of the present invention provides a hydraulic turbine engine comprising, between a seat and a succession of turbine stages associated with at least one generator, a guiding block removably attached to the lower stage of the turbine engine and nested on the seat, the guiding block containing winders of guiding cables having their ends secured to the seat.

According to an embodiment of the present invention, the winders are power-driven winches.

According to an embodiment of the present invention, the seat comprises vertical spindles into which complementary elements of the guiding blocks nest, the guiding cables being attached to said spindles.

According to an embodiment of the present invention, the turbine engine comprises an active portion and a holding structure attached to the seat, where only the active portion is removable.

According to an embodiment of the present invention, the holding structure comprises vertical posts having the shape of split sleeves, and the active portion comprises lateral posts capable of inserting into said sleeve-shaped posts, the guiding cables running through a lower portion of the posts of the active portion of the machine and being attached to the bottom of the sleeve-shaped posts.

According to an embodiment of the present invention, the sleeve-shaped posts comprise latches which close when the lateral posts of the active portion of the turbine engine are extracted from the sleeve-shaped posts, to maintain the guiding cables inside of the posts.

According to an embodiment of the present invention, the turbine engine comprises two twin columns and the seat comprises a central pile into which a central portion of the turbine engine engages.

According to an embodiment of the present invention, the pile rises up to the surface of the liquid medium where the turbine engine is immersed.

An embodiment of the present invention provides a method for dismounting a turbine engine such as hereabove, from a vessel provided with lifting means and with grasping means, comprising the steps of bringing the vessel on site; lifting the turbine engine with the lifting means attached to an upper portion of the turbine engine; once the top of the turbine engine has reached the vessel level, having the grasping means grasp the guiding block; dismounting the turbine engine stage by stage while the turbine engine is being lifted in stages by means of the grasping means; and lowering the guiding block until it is engaged with the spindles of the seat towards which it is guided by the guiding means.

An embodiment of the present invention provides a method for mounting a turbine engine such as hereabove, from a vessel provided with lifting means and with grasping means, comprising the steps of bringing the vessel on site; lifting the guiding block with the lifting means attached to an upper portion of the guiding block; once the guiding block has reached the vessel level, grasping it with the grasping means; mounting the turbine engine stage by stage while the turbine engine is being lowered by means of the grasping means; and lowering the turbine engine with the lifting means attached to an upper portion of the turbine engine until the guiding block is engaged with the spindles of the seat.

### BRIEF DESCRIPTION OF THE DRAWINGS

The foregoing and other objects, features, and advantages of the present invention will be discussed in detail in the following non-limiting description of specific embodiments in connection with the accompanying drawings, among which:

FIG. 1 is an exploded perspective view of a turbine engine;

FIGS. 2A and 2B are simplified perspective views of a cross-flow hydraulic turbine engine, respectively in the mounted state and at an intermediate lifting phase;

FIG. 3 is a simplified perspective view of a guiding block used in the turbine engine of FIGS. 2A and 2B;

FIGS. 4A to 4F illustrate successive steps of the lifting of a turbine engine column;

FIGS. 5A to 5F illustrate successive steps of the lowering of a turbine engine column;

FIGS. 6A and 6B are perspective views showing a turbine engine column with a holding structure, in the mounted state and at an intermediate lifting phase;

FIG. 6C is a perspective view of a guiding block used in the turbine engine of FIGS. 6A and 6B;

FIGS. 6D and 6E show details of the turbine engine of FIGS. 6A to 6B;

FIGS. 7A to 7F illustrate successive steps of the lifting of a turbine engine column with a holding structure;

FIGS. 8A and 8B are simplified perspective views of a turbine engine with a fairing in the mounted state and at an intermediate lifting phase;

FIGS. 9A and 9B are perspective views of a turbine engine with twin columns in the mounted state and at an intermediate lifting phase;

FIGS. 10A and 10B show another example of a turbine engine with twin columns in the mounted state and at an intermediate lifting phase;

FIG. 11 is a perspective view of a variation of a turbine engine with a fairing at an intermediate lifting phase; and

FIG. 12 shows still another example of a twin-column turbine engine at an intermediate lifting phase.

For clarity, identical or equivalent elements have been designated with the same reference numerals in the different drawings. Further, when the same elements are reproduced in successive drawings, the corresponding reference numerals are not systematically repeated.

### DETAILED DESCRIPTION

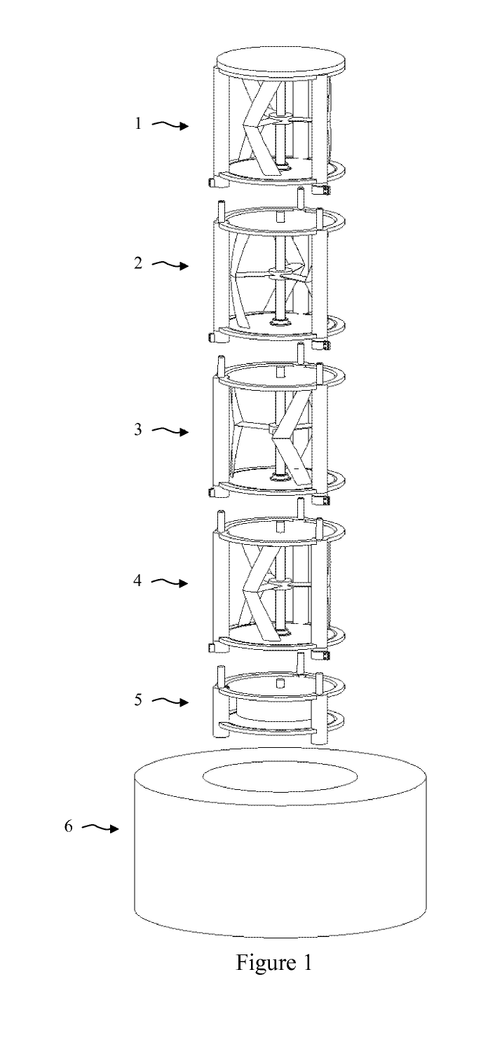

FIG. 1 is an exploded perspective view of a simplified example of a single-column cross-flow hydraulic turbine engine. This turbine engine comprises four turbine stages 1, 2, 3, 4 and one generator shaft 5. The stages have a common shaft, the turbine stages for example being of the type described in above-mentioned French patent application 04/50209. Each of the stages comprises means of assembly with the adjacent stage(s), and coupling means (not shown) are provided between the turbine and generator shafts. The turbine engine further comprises a guiding block 6 containing winders/unwinders or winches having a function which will be described hereinafter. In the shown example, generator 5 inserts into guiding block 6.

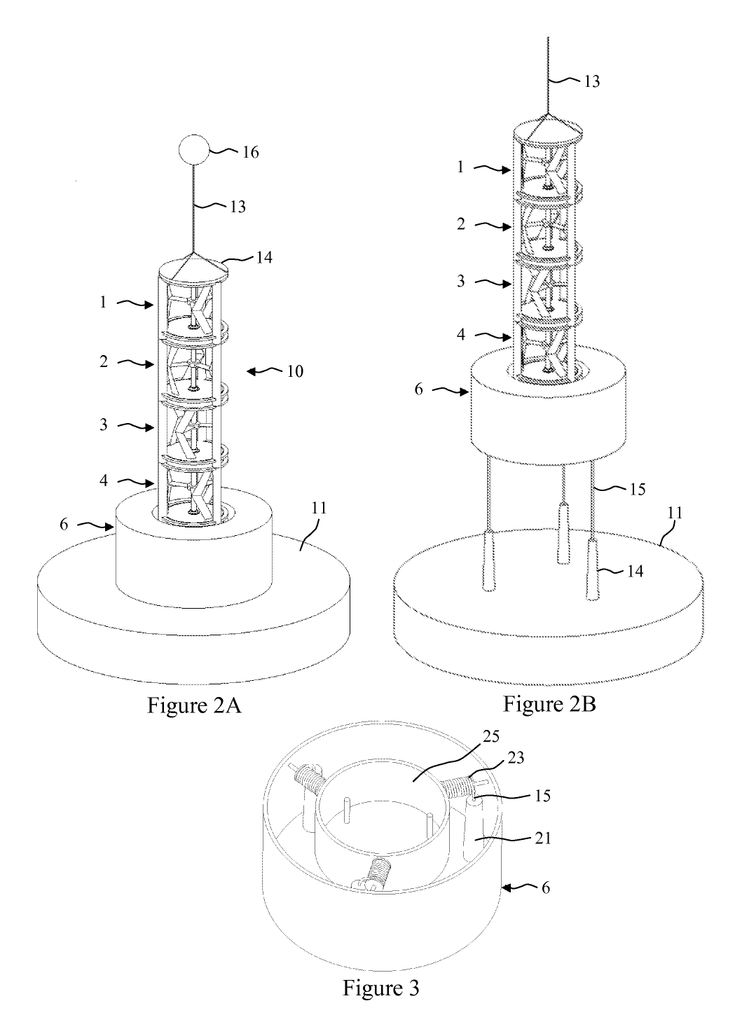

FIG. 2A shows a single-column turbine engine 10 of the same type as that illustrated in exploded view in FIG. 1, in the mounted state. Base 6 rests on a seat or foundation 11. Seat 11 is very symbolically shown. Generally, it will be a block of significant mass intended to maintain the turbine engine on a sea or river bed at a location where a current capable of driving the turbines is present. Grasping or hooking means 13 are connected to an upper plate 14 of the turbine engine. They are for example formed of a cable hooked to this upper plate, the end of the cable being connected to a buoy 16.

FIG. 2B shows turbine engine 10, in a state where it is pulled upwards by cable 13. Spindles 14 extend upwards from the foundation. A guiding cable 15 coming from a winder or winch of guiding block 6 is attached to each of these spindles (or in each of these spindles).

FIG. 3 is a perspective view of guiding block 6, without its upper plate. On the lower surface side of block 6, are formed openings, preferably surrounded with a conical sleeve 21, capable of coupling with spindles 14 to maintain the turbine engine in place when it is placed on seat 11. Guiding cables 15 illustrated in FIG. 2B are wound on a winder or winch 23. A central area 25 of guiding block 6 is intended to receive generator 5. Means for fastening this generator or another element of the turbine engine structure (not shown) are also provided. Each of winders 23 enables to unwind guiding cables 15 by maintaining a tension when the column is pulled up by means of cable 13. Conversely, these winders are capable of maintaining guiding cables 15 under tension on lowering of a column. To optimize this lowering operation and provide a reliable nesting of the guiding block into spindles 14 of the seat, it is preferably provided for each of winders 23 to be a winch associated with a driving element, for example, electric or pneumatic, not shown.

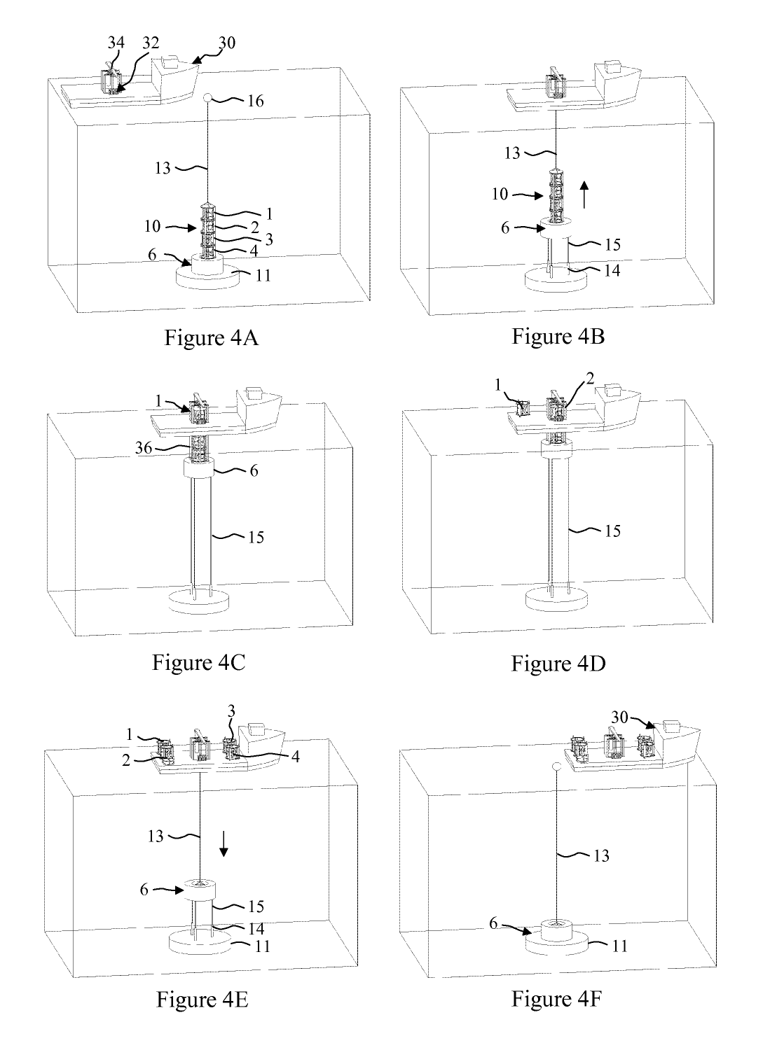

FIGS. 4A to 4F illustrate steps of dismounting of a single-column hydraulic turbine engine, of the type in FIGS. 1 to 3, for example for a maintenance operation.

The operations are performed from a conventional vessel 30 provided with an access hole 32 associated with lifting means 34. A vessel with a central access hole has been shown. It may also be provided for the operations to be performed from the rear platform of a vessel, from a barge pulled by a vessel, or from a vessel of floating shearlegs type.

In FIG. 4A, a vessel arrives on site and spots buoy 16 of traction cable 13. It should be noted that the presence of a buoy 16 associated with a traction cable 13 is a possible embodiment only. It may be provided for the top of the turbine engine to comprise active or passive signaling means that can be spotted from the vessel. The vessel can then send appropriate grasping means, for example, a hook system or an electromagnet system, to the top of the turbine engine.

At the step illustrated in FIG. 4B, the vessel has hooked cable 13 to lifting means 34 and has started lifting the turbine engine while cables 15 secured to spindles 13 unwind as guiding block 6 rises.

To have an idea of the means necessary for this operation, it should be noted, as an example only, that if the turbine elements have a diameter on the order of 3 meters and a height on the order of 3 meters, each element will weight on the order of one ton, which weight may be lower if the turbine elements are made of a composite material. Thus, the structure to be raised will have a weight on the order of 5 tons.

At the step of FIG. 4C, the top of the turbine engine, substantially corresponding to upper stage 1, is taken out of the water. At this time, guiding block 6 is grasped with appropriate means provided on the vessel, for example, cylinders 36 having their lower portion provided with hooking electromagnets. Then, cable 13 may be unhooked and upper stage 1 may be dismounted.

At the step shown in FIG. 4D, the upper turbine stage 1 has been dismounted and placed on the vessel deck. Cylinders 36 have been raised to expose second turbine stage 2. Again, this stage is dismounted and placed aside.

At the step illustrated in FIG. 4E, the four turbine stages 1 to 4 have been dismounted and placed on the vessel deck. After this, cable 13 is fastened to the upper portion of guiding block 6 and the guiding block is lowered along cable 13 while being guided and possible driven by cables 15.

Eventually, at the step shown in FIG. 4F, the guiding block is put back in place on seat 11 and the vessel resumes its course to transport the various turbine engine stages to a maintenance workshop, if it is not equipped to maintain them in situ.

As indicated previously, cables 15 are connected to winders/unwinders ensuring the tension of these cables during the lowering. Preferably, these winders are power-driven winches. A power source, for example, an electric cable or a pneumatic line is connected from the vessel to these motors to drive them, which may help the nesting of guiding block 6 on spindles 14 of seat or foundation 11. Once the guiding block is in place, the electric cable or the pneumatic line may be uncoupled from the guiding block by being pulled out and back onto the vessel, or may be held in place at the guiding block level, its upper portion being hooked to buoy 16 if such a buoy is provided.

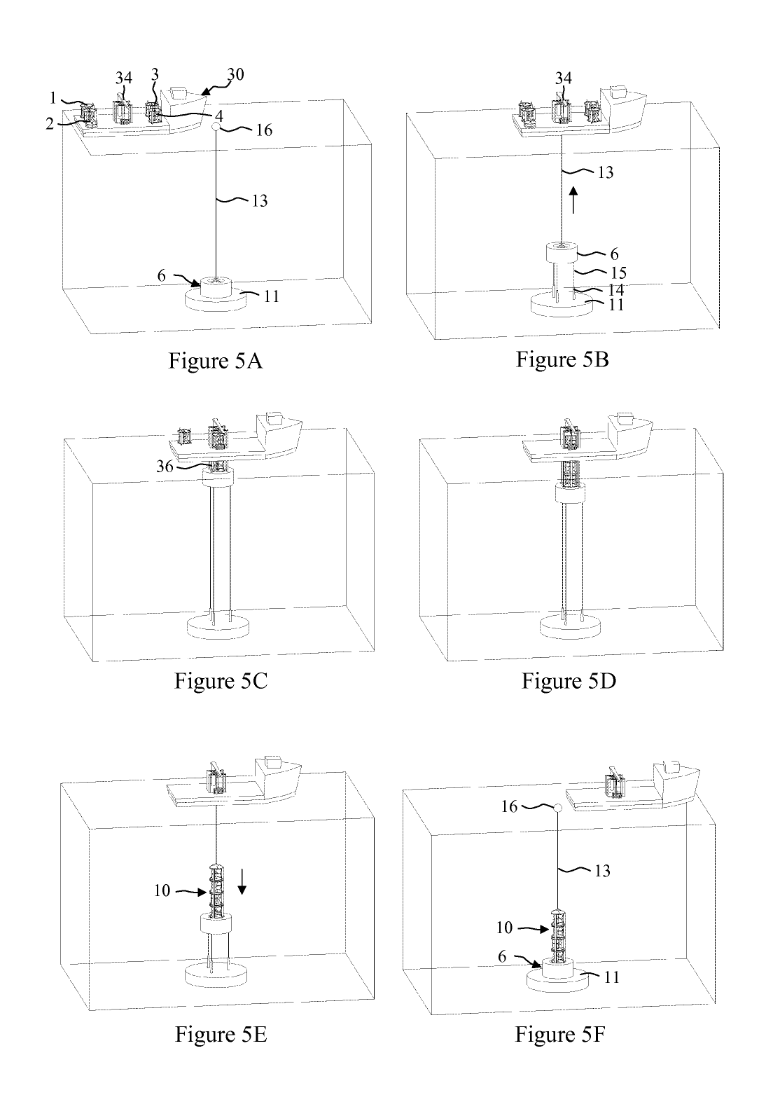

FIGS. 5A to 5F illustrate successive steps of the putting back in place of a turbine engine of the type in FIGS. 1 to 3.

It should be noted that these steps of putting back in place may be performed directly after the steps described in relation with FIG. 4D, before lowering of the guiding block if a survey of the various stages has revealed their good condition, if the vessel has brought replacement stages, or again if the maintenance operations could be performed directly onboard the vessel.

It should however be noted that it is started from the state illustrated in FIG. 4F, also shown in FIG. 5A.

FIG. 5A shows vessel 30 provided with replacement turbine stages. Again, the vessel spots buoy 16 or other signaling means and takes its position.

At the step illustrated in FIG. 5B, guiding block 6 has started being pulled up by lifting means 34.

As illustrated in FIGS. 5C and 5D, while guiding block 6 is connected to the vessel by electromagnet cylinders 36 or other grasping and lifting means, the different stages are successively mounted on guiding block 6.

After this, turbine engine 10 is progressively lowered as illustrated in FIG. 5E and installed as illustrated in FIG. 5F, in the same way as described previously for the lowering of the guiding block alone.

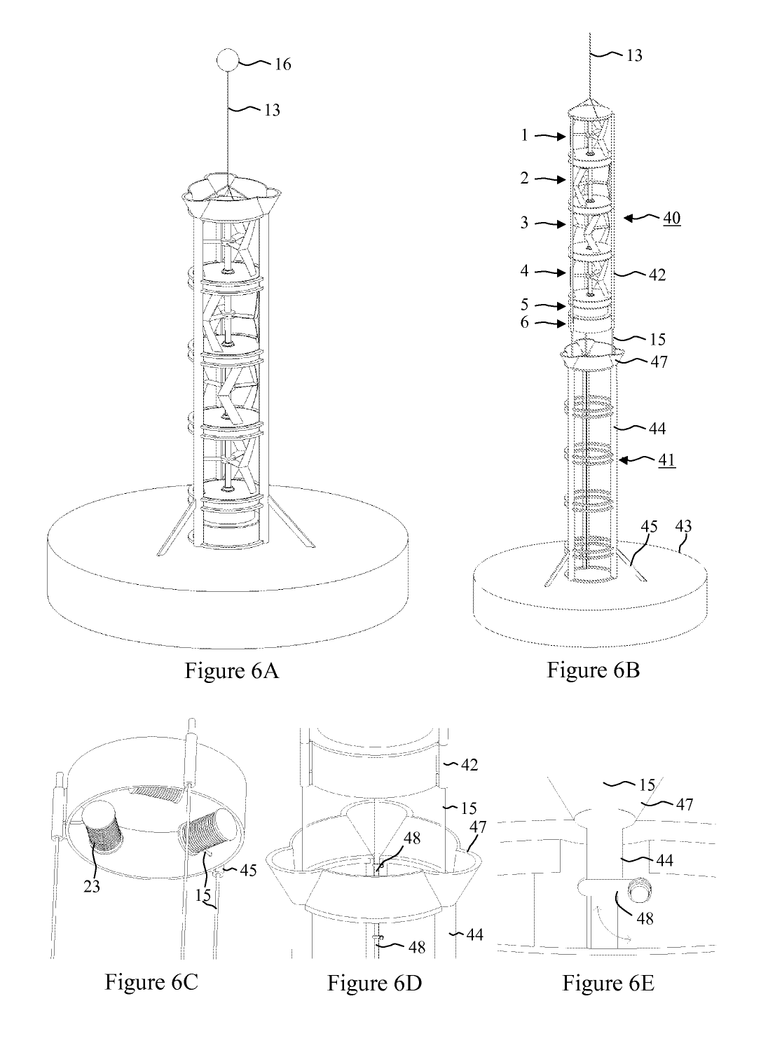

FIGS. 6A to 6E illustrate the case of a turbine engine associated with a holding structure, for example, as described in above-mentioned French patent application 05/50420.

FIG. 6A is a simplified perspective view illustrating such a turbine engine type while it is being installed and FIG. 6B shows this turbine engine while its active portion 40 is lifted with respect to holding structure 41. It should be reminded that the advantage of such a holding structure is that the active elements may be lighter, the resistance to efforts being essentially provided by holding structure 41. In this example, turbine engine 40 comprises four turbine stages 1, 2, 3, 4, and one generator stage 5, the assembly being secured to a lower guiding block 6. Turbine engine 40 comprises lateral posts 42 which are capable of engaging into split posts forming sleeves 44 of the holding structure. Holding structure 41 is directly secured to a foundation 43. Lateral stiffeners 45 may be provided to strengthen the structure. Each post 44 of the holding structure preferably comprises an upper flaring 47 to ease the introduction of posts 42 of the turbine engine. As previously, cables 15 mounted on winders of guiding block 6 are connected to the seat. This time, they run inside of hollow posts 44 of the holding structure to guide the insertion of posts 42 into posts 44.

FIG. 6C shows a detail of the guiding block. Cables 15 wound around winches 23 laterally come out of the guiding block into lateral posts 45 of this guiding block belonging to the set of posts 42 illustrated in FIG. 6B.

FIG. 6D shows an enlargement of the upper portion of holding structure 41. It better shows an example of flaring 47 of hollow posts 44 into which posts 42 of the actual turbine engine and guiding cables 15 engage.

As shown by the detail view of FIG. 6E, to avoid for cables 15 to risk coming out of posts 44 when posts 42 have been taken out of posts 44 and when the actual turbine engine is not engaged in the holding structure, a latch 48 equipped with a torsion spring may be provided. This latch is in low position when posts 42 are engaged in posts 44 and automatically rises back to the shown position when posts 42 have past the latch level. Cable 15 is thus guided at the level of the high portion of posts 44. As shown in

FIG. 6D, several latches 48 may be provided along a hollow post 44.

Once active portion 40 of the turbine engine has been pulled up to the level of a vessel, its dismounting and mounting back will be similar to those previously described in relation with FIGS. 4A-4F and 5A-5F. The advantage of the embodiments of FIGS. 6A to 6E is, as indicated, that the structure to be moved is lighter than in the case of the embodiment of FIGS. 1 to 3. Conversely, for a given weight, a column with more stages may be provided.

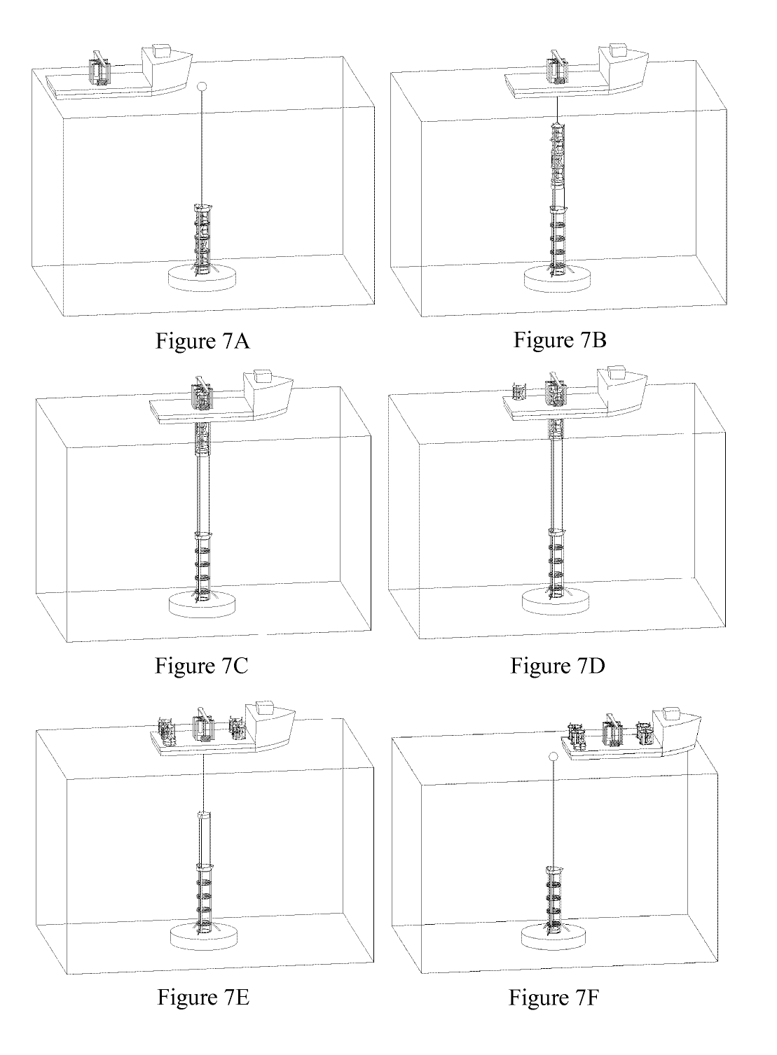

FIGS. 7A to 7F are simplified views illustrating the lifting of a turbine engine column of the type in FIGS. 6A and 6B.

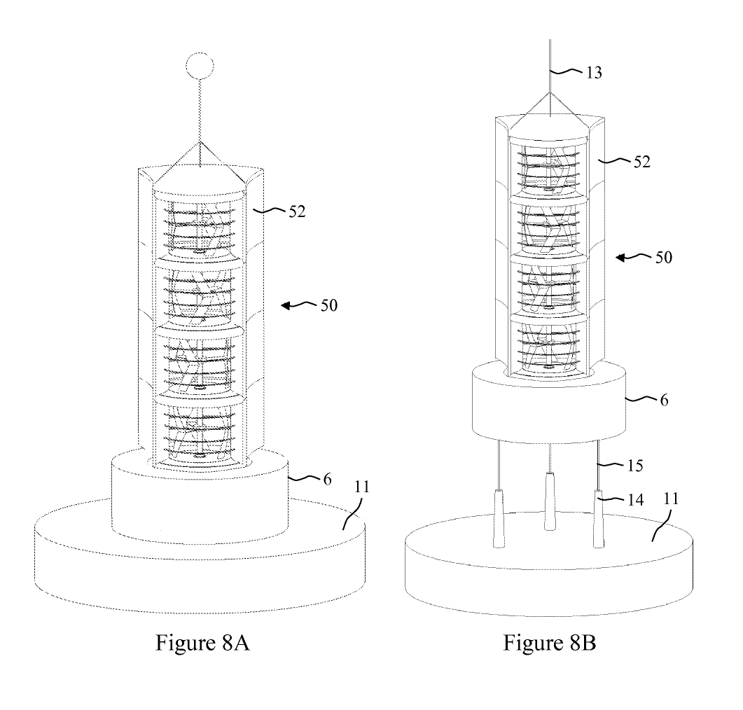

FIGS. 8A and 8B are perspective views of another embodiment of a single-column turbine engine in which turbine engine 50 is a turbine engine provided with a fairing 52, which advantageously enables it to automatically place itself in accordance with the direction of a current. The turbine engine is mounted on a central portion (not shown) of guiding block 6 to freely rotate around a vertical axis with respect to seat 11.

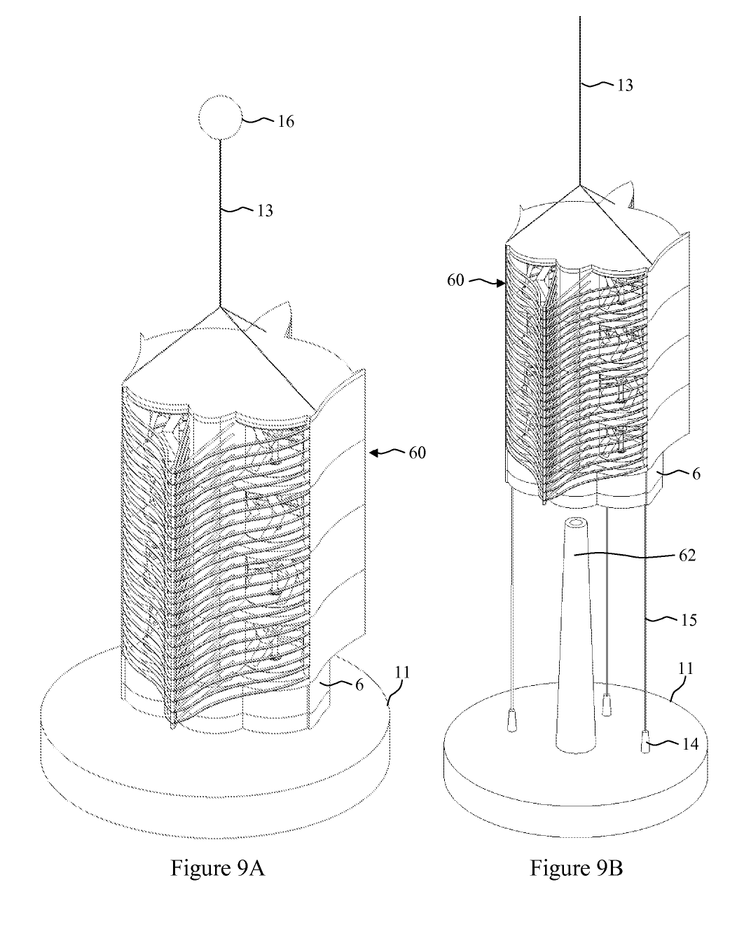

FIGS. 9A and 9B show an example in which turbine engine 60 comprises two twin columns rotating in reverse directions, of the type described in above-mentioned French patent application 07/58511. As previously, a guiding block 6 comprising winders or winches, not shown, on which guiding cables 15 are wound, is provided at the bottom of the structure. Further, in the shown example, in addition to spindles 14 for the nesting of holding block 6, a central pile 62 substantially having the height of the turbine engine and intended to stiffen it and improve its fastening is provided. As in the case of single-column turbine engine with a fairing of FIGS. 8A and 8B, the turbine engine is assembled on a central portion (not shown) of guiding block 6 to freely rotate around a vertical axis with respect to seat 11.

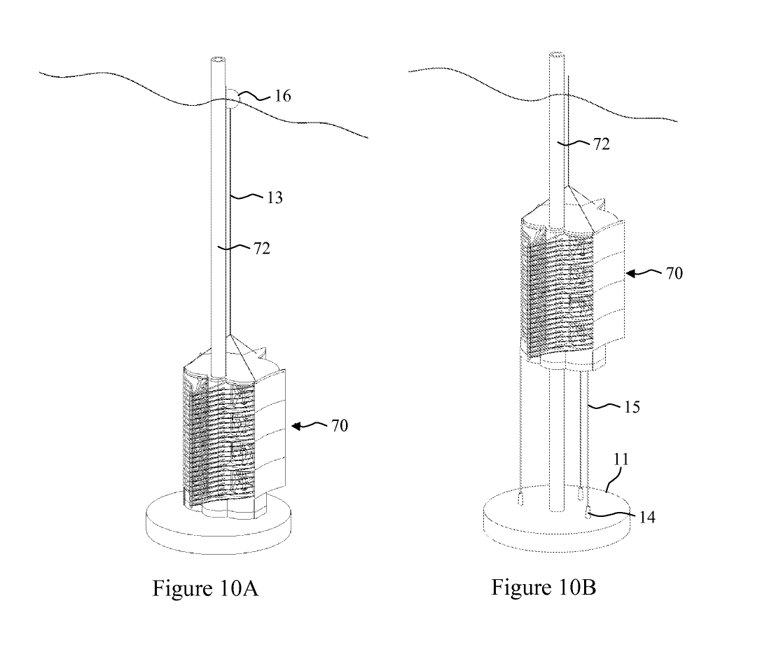

FIGS. 10A and 10B show a structure similar to that of FIGS. 9A and 9B but in which central pile 72 substantially extends all the way to the surface of the medium where the turbine engine is immersed. It should be understood that such a structure is adapted to environments where the turbine engine is not installed at great depths, and especially where there are no specific navigation constraints above the turbine engines. The presence of such a pile rising up to the surface especially simplifies the handling of the various lifting and electric power supply cables of the turbine engine. Further, this enables to lighten the structure, since the rigidity is essentially provided by the central pile.

### Variations

The present invention has been described in the context of various embodiments. It should be understood by those skilled in the art that the turbines and generators may have many variations, examples of which may especially be found in the prior French applications of the applicant, without for this to be a limitation. As other variations, the following elements may be pointed out.

Instead of providing several turbine stages associated with a single generator stage, all stages having a common shaft, it may be provided for each of the stages to comprise an assembly of a turbine and of a generator, the shafts of the various stages being independent. This has the advantage of simplifying the assembly. This further enables to rotate different stages in opposite rotation directions, which especially has the advantage of decreasing efforts due to the lift.

The means for pulling a turbine engine or elements thereof towards the surface, as well as the means for spotting the top of an immersed turbine engine and for grasping the guide block from the vessel deck from the moment that the top of the turbine engine has reached the high lifting portion of the vessel deck may have many variations, some of which have been discussed hereabove.

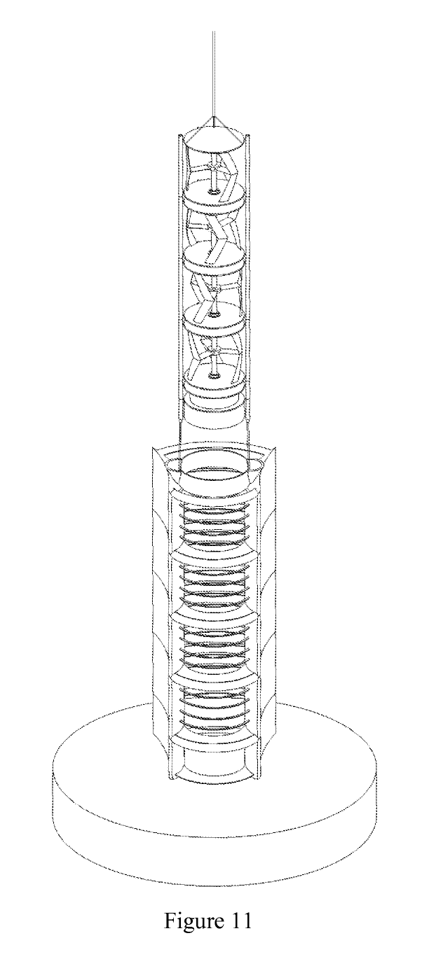

In the case of a turbine engine with a fairing, a structure such that the fairing forms a holding structure which remains solidly attached to the seat when the active elements of the actual turbine engine are lifted may be provided. This is illustrated in FIG. 11.

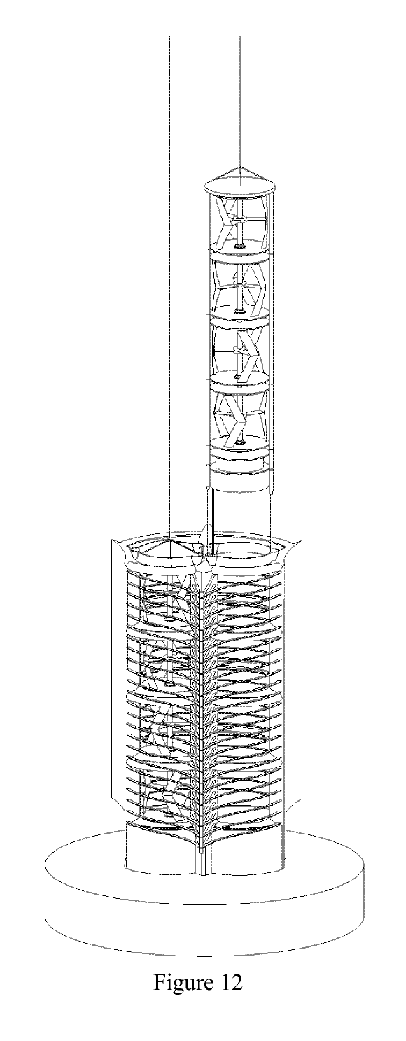

In the case of a twin-column turbine engine, it may be provided to be able to separately dismount each of the columns. This is illustrated in FIG. 12.

Guiding and traction cables have been mentioned several times herein. It should be clear that such cables may be replaced with any equivalent traction line, such as ropes or chains.

Further, various embodiments with different variations have been described hereabove. Those skilled in the art may combine various elements of these various embodiments and variations without showing any inventive step.

1. A hydraulic turbine engine comprising, between a seat (11) and a succession of turbine stages (1-4) associated with at least one generator (5), a guiding block (6) removably attached to the lower stage of the turbine engine and nested on the seat, the guiding block containing winders (23) of guiding cables (15) having their ends secured to the seat.

2. The turbine engine of claim 1, wherein the winders are power-driven winches.

3. The turbine engine of claim 1, wherein the seat (11) comprises vertical spindles (14) into which complementary elements (21) of the guiding blocks (6) nest, the guiding cables (15) being attached to said spindles.

4. The turbine engine of any of claim 1, comprising an active portion (40) and a holding structure (41) attached to the seat, where only the active portion is removable.

5. The turbine engine of claim 4, wherein the holding structure (41) comprises vertical posts having the shape of split sleeves (44), and the active portion (40) comprises lateral posts (42) capable of inserting into said sleeve-shaped posts, the guiding cables (15) running through a lower portion of the posts of the active portion of the machine and being attached to the bottom of the sleeve-shaped posts.

6. The turbine engine of claim 5, wherein the sleeve-shaped posts comprises latches (48) which close when the lateral posts (42) of the active portion of the turbine engine are extracted from the sleeve-shaped posts (44), to maintain the guiding cables inside of the posts.

7. The turbine engine of any of claim 1, comprising two twin columns, wherein the seat comprises a central pile (62) into which a central portion of the turbine engine engages.

8. The turbine engine of claim 7, wherein the pile (72) rises up to the surface of the liquid medium where the turbine engine is immersed.

9. A method for dismounting the turbine engine of claim 1, from a vessel provided with lifting means (34) and with grasping means (36), comprising the steps of:
bringing the vessel (30) on site;
lifting the turbine engine from the lifting means (34) attached to an upper portion of the turbine engine;
once the top of the turbine engine has reached the vessel level, having the grasping means (36) grasp the guiding block (6);
dismounting the turbine engine stage by stage while the turbine engine is being lifted in stages by means of the grasping means; and
lowering the guiding block until it is engaged with the spindles of the seat (11) towards which it is guided by the guiding means.

10. A method for mounting the turbine engine of claim 1, from a vessel provided with lifting means (34) and with grasping means (36), comprising the steps of:
bringing the vessel (30) on site;
lifting the guiding block (6) with the lifting means attached to an upper portion of the guiding block;
once the top of the guiding block (6) has reached the level of the vessel, grasping it with the grasping means (36);
mounting the turbine engine stage by stage while the turbine engine is being lowered in stages by means of the grasping means; and
lowering the turbine engine with the lifting means attached to an upper portion of the turbine engine until the guiding block is engaged with the spindles of the seat (11).
